(19) United States
(12) Patent Application Publication
(10) Pub. No.: US 2008/0244011 A1
(43) Pub. Date: Oct. 2, 2008

(54) System and Method for providing instant messaging session backups

(76) Inventors: Patrick Herbert Cox, Raleigh, NC (US); Patrick Gabriel McGowan, Chapel Hill, NC (US); Jeremy Gray Perry, Cary, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/693,840

(22) Filed: Mar. 30, 2007

(51) Int. Cl. G06F 15/16

(52) U.S. Cl. 709/206

(57) ABSTRACT

A system, method, and program product are provided that receives an instant messaging request from a sender over a network, such as the Internet. The instant messaging request is directed to requesting an instant messaging session with a primary recipient. The system determines whether the primary recipient is available. If the primary recipient is available, the system sets up the instant messaging session with the primary recipient. On the other hand, if the primary recipient is unavailable, the system identifies a backup recipient. This is accomplished by retrieving stored backup recipient identifiers that correspond to one or more backup recipients associated with the primary recipient. At least one available backup recipient identifier from the one or more stored backup recipient identifiers is identified, and the instant messaging session is set up with the identified (available) backup recipient.

### BACKGROUND OF THE INVENTION

1. Technical Field

The present invention relates to a system and method that provides a backup recipient in an instant messaging session. More particularly, the present invention provides a variety of factors that are used in selecting a backup for an intended instant messaging recipient.

2. Description of the Related Art

Instant messaging is an increasingly popular method of communicating in many environments. Participants in instant messaging sessions often engage in several instant messaging sessions at the same time or perform other work while engaging in an instant messaging session. This level of multitasking is possible using traditional telephone conversations. Instant messaging also provides a more “real time” interaction as opposed to sending and receiving traditional email messages.

Business environments are increasingly using instant messaging for various functions. For example, instant messaging can be used in a “help desk” environment, in addition to, or in lieu of, traditional telephone help desk support and email support. Telephone help desk service is typically more expensive for the organization because an employee is often dedicated to one help desk call at a time. When the customer is performing tasks or waiting for an operation to complete on the customer's computer system, the help desk employee is often forced to wait for the customer to be able to continue the call. This downtime cannot typically be used to help other customers waiting for help. On the other hand, email help desk support is typically disliked by customers because of the extensive time period between when the customer sends the email asking for help and receiving a responsive email. In addition, because the email is not as interactive, if the responsive email did not solve the problem, the customer needs to clarify the situation causing the problem and send another email, further lengthening the time before the problem can be fixed.

Because of its popularity and flexibility, instant messaging is being used in a wide variety of business functions. Using instant messaging in a business environment, however, does present certain challenges to both organizations and the participants of the instant messaging sessions. One challenge is referred to as “chat backlog.” Chat backlog occurs when a user is away from their desk or otherwise unavailable to engage in instant messaging sessions for some period of time. Upon return, the user may be met with a barrage of instant messaging screens from others that have been waiting to communicate with the user. Chat backlog may cause the user to ignore some instant messaging requests due to time constraints which may upset individuals, such as customers, that are trying to engage in an instant messaging session with the user. Chat backlog may also cause confusion when a single user is attempting to engage in too many chat sessions at the same time. This confusion may result in incorrect information or advice being sent to some customers or other individuals, upsetting the customers and individuals.

### SUMMARY

It has been discovered that the aforementioned challenges are resolved using a system, method and computer program product that receives an instant messaging request from a sender over a network, such as the Internet. The instant messaging request is directed to requesting an instant messaging session with a primary recipient. The system determines whether the primary recipient is available. If the primary recipient is available, the system sets up the instant messaging session with the primary recipient. On the other hand, if the primary recipient is unavailable, the system identifies a backup recipient. This is accomplished by retrieving stored backup recipient identifiers that correspond to one or more backup recipients associated with the primary recipient. At least one available backup recipient identifier from the one or more stored backup recipient identifiers is identified, and the instant messaging session is set up with the identified (available) backup recipient.

In one embodiment, the system retrieves an availability code corresponding to the primary recipient that identifies whether the primary recipient is available. The system further retrieves one or more preferred sender identifiers corresponding to the primary recipient and compares the preferred sender identifiers with the sender identifier that corresponds with the sender making the request. Determining whether the primary recipient is available includes determining if the sender identifier matches one of the preferred sender identifiers. If the sender identifier fails to match one of the preferred sender identifiers, then, based on the same availability code, the primary recipient is deemed to be unavailable.

In another embodiment, the system receives the instant messaging and the request identifies an instant messaging group with whom the sender wishes to have an instant messaging session. For example, in a home improvement setting, the sender may want to set up an instant messaging session with someone in the plumbing department to discuss some plumbing questions. In this embodiment, a primary recipient identifier is retrieved that based on the requested instant messaging group.

In yet another embodiment, the available backup recipient identifier includes more than one available backup recipient identifiers. In this embodiment, the list of available backup recipient identifiers is returned to the sender via the computer network and the sender selects the recipient from the list.

In one embodiment, after the backup recipient is identified and the sender engages in an instant messaging session with the backup recipient, an instant messaging session log is created and stored capturing the messages sent during the instant messaging session. This log is made accessible to the primary recipient. For example, the primary recipient can audit sessions conducted by backup recipients for quality control purposes or in order to understand a customer's problem in case the backup recipient was unable to resolve the sender's issues or problems. In a further embodiment, after the instant messaging session has been set up with the backup recipient, the primary recipient can view the instant messaging session log and, upon request by the primary recipient, a second instant messaging session can be established between the primary recipient and the sender. In addition, the contents of the session log between the sender and the backup recipient are displayed to the primary recipient.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a high-level diagram showing components used to provide instant messaging backups;

FIG. 2 is a flowchart showing the steps taken to configure instant messaging groups used in instant messaging backup operations;

FIG. 3 is a flowchart showing the steps taken to setup an instant messaging profile for instant messaging recipients;

FIG. 4 is a flowchart showing the steps taken to select backup recipients for an individual instant messaging recipient;

FIG. 5 is a flowchart showing the steps taken during an instant messaging session with a group that includes instant messaging backups;

FIG. 6 is a flowchart showing the steps taken to select a group backup recipient for an instant messaging session;

FIG. 7 is a flowchart showing the steps taken during an instant messaging session with individual that has designated instant messaging backup recipients;

FIG. 8 is a flowchart showing the steps taken to select an individual backup recipient for an instant messaging session;

FIG. 9 is a flowchart showing the steps taken to allow a primary recipient to cut into a session between a sender and a backup recipient; and

FIG. 10 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

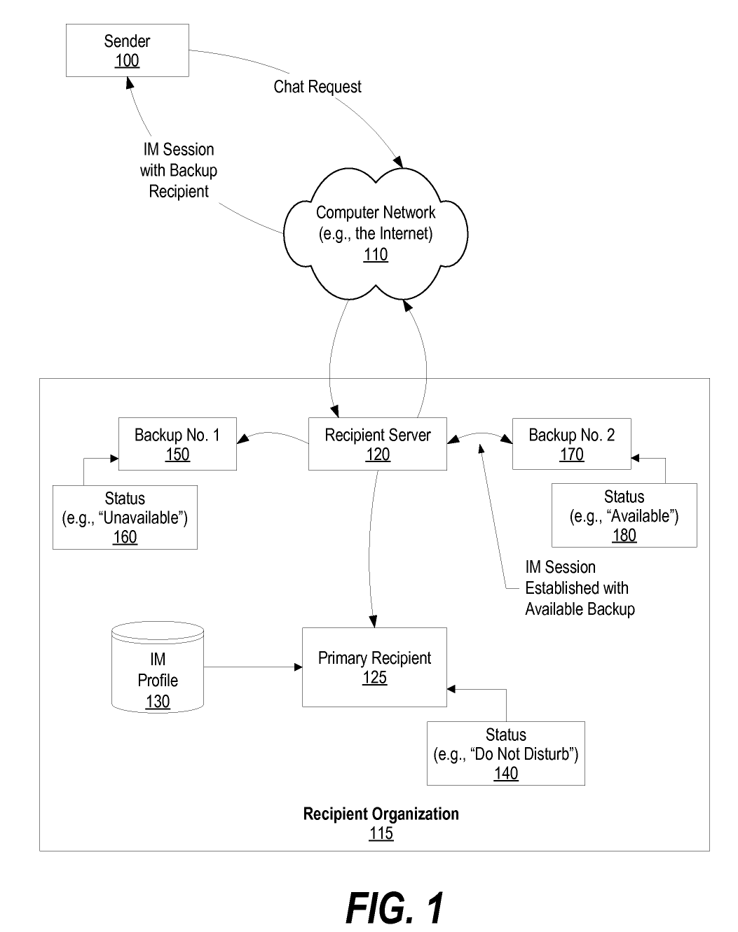

FIG. 1 is a high-level diagram showing components used to provide instant messaging backups. Sender 100 begins by sending an instant messaging request through computer network 110 to recipient organization 115. The request is received at recipient server 120. Recipient server 120 runs a process to identify a recipient for the sender's instant messaging request. Primary recipient 125 is first checked to see if the primary recipient is available. If the primary recipient is available, then the recipient server sets up an instant messaging session between the sender and the primary recipient. In order to determine if the primary recipient is available, the server checks status field 140 that corresponds to the primary recipient. In addition, instant messaging profile 130 is used to determine whether the primary recipient is available. Instant messaging profile 130 can store a list of “preferred senders” that are able to set up instant messaging sessions with the primary recipient even though the primary recipient's status may indicate that the primary recipient is unavailable. For example, the primary recipient may set up his profile to allow important customers or the primary recipient's manager to set up an instant messaging session even if the primary recipient's status is “Do Not Disturb.”

If the primary recipient is unavailable to the sender, then recipient server 120 cycles through backup recipients in order to identify a backup recipient that is available for an instant messaging session with the sender. In the example shown, status 160 corresponding to first backup 150 indicates that the first backup is also unavailable, however status 180 corresponding to second backup 170 indicates that the second backup recipient is available. Consequently, in the example shown, recipient server 120 sets up an instant messaging session between sender 100 and second backup recipient 170.

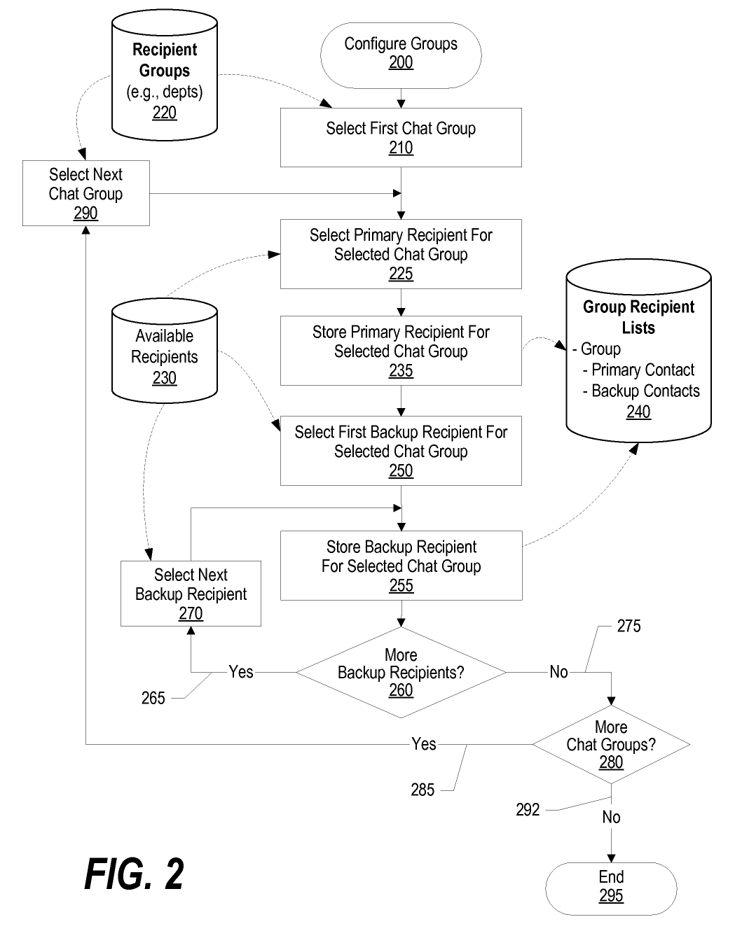

FIG. 2 is a flowchart showing the steps taken to configure instant messaging groups used in instant messaging backup operations. Processing commences at 200 whereupon, at step 210, the first instant messaging group is selected from recipient groups 220. Examples of recipient groups in an organization might be various departments. In a home improvement store setting, recipient groups might include groups such as plumbing, electrical, paint, hardware, lumber, and the like. At step 225, the primary recipient for the selected recipient group is selected from available recipients 230. In the home improvement example, the primary recipient for a given department may be chosen based on experience or other criteria. In addition, an available recipient can be chosen to be a recipient for multiple recipient groups (e.g., one employee can be a recipient for both plumbing and electrical). At step 235, the primary recipient for the selected recipient group is stored in group recipient lists 240.

At step 250, the first backup recipient is selected for the selected recipient group from list of available recipients 230. At step 255, the selected backup recipient is stored in group recipient lists 240. A determination is made as to whether there are more backup recipients for the selected recipient group (decision 260). If there are more backup recipients, then decision 260 branches to “yes” branch 265 whereupon, at step 270, the next backup recipient for the selected recipient group is selected from list of available recipients 230 and processing loops back to store the newly selected backup recipient in group recipient lists 240. This looping continues until there are no more backup recipients to select for the recipient group, at which point decision 260 branches to “no” branch 275.

Another determination is made as to whether there are more instant messaging recipient groups to configure (decision 280). If there are more instant messaging recipient groups to configure, then decision 280 branches to “yes” branch 285 whereupon, at step 290, the next recipient group is selected from recipient groups 220 and processing loops back to select the primary recipient and the backup recipients for the newly selected recipient group. This looping continues until there are no more recipient groups to configure, at which point decision 280 branches to “no” branch 292 and processing used to configure instant messaging recipient groups ends at 295.

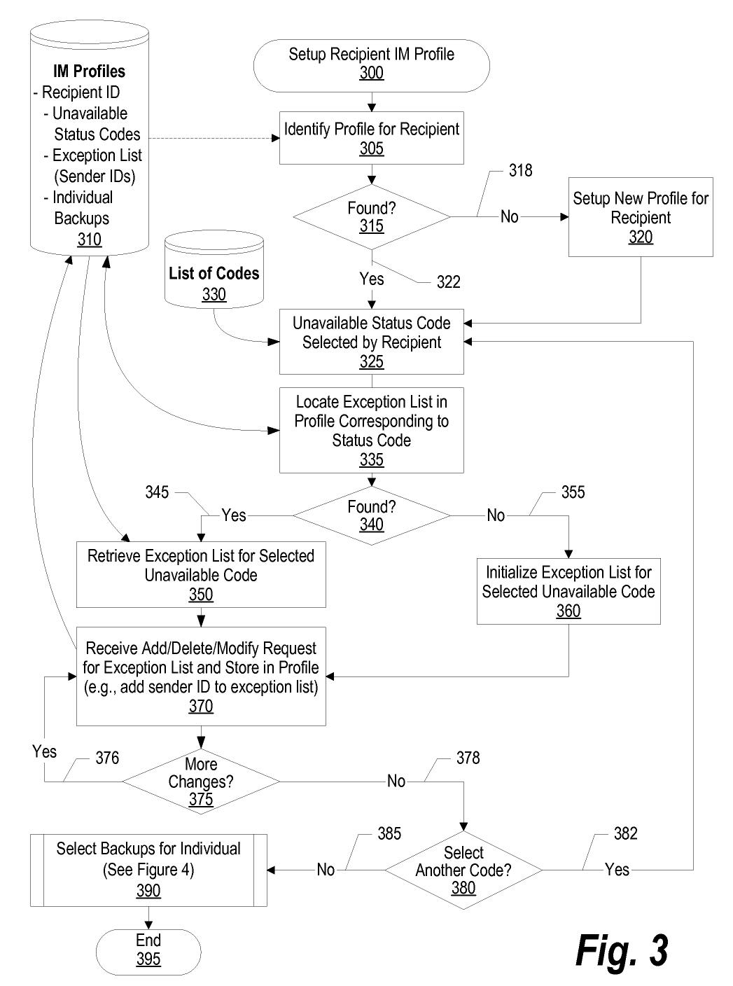

FIG. 3 is a flowchart showing the steps taken to setup an instant messaging profile for instant messaging recipients. Processing commences at 300 whereupon, at step 305, an instant messaging profile is identified (or created) for a recipient. Instant messaging profiles 310 include information such as the recipient's unique identifier (e.g., email address, instant messaging name, etc.), the recipient's unavailable status codes, exception lists that identify sender identifiers (e.g., sender's email address, instant messaging name, etc.) corresponding to senders that can establish instant messaging sessions with the recipient when the recipient is otherwise unavailable. For example, the recipient may identify an important customer in the exception list so that the important customer can establish an instant messaging session even when the recipient's status is “Do Not Disturb.” However, for other unavailable status codes, such as “On Vacation” or “Out of Office,” there may not be an exception list as the recipient is truly unavailable.

A determination is made as to whether an instant messaging profile is found for the recipient (decision 315). If a profile is not found for the recipient, then decision 315 branches to “no” branch 318 whereupon, at step 320, a new profile is created for the recipient. On the other hand, if a profile has already been created for the recipient, then decision 315 branches to “yes” branch 322 bypassing step 320. At step 325, an unavailable status code is selected by the recipient from list of unavailable status codes 330. At step 335, the selected unavailable status code is located in the recipient's profile, including the exception list may have been established for the status code.

A determination is made as to whether the selected unavailable status code is already in the recipient's profile (decision 340). If the code is already in the recipient's profile, then decision 340 branches to “yes” branch 345 whereupon, at step 350, the exception list of senders that are allowed to establish instant messaging sessions with the recipient when the recipient's status is set to the selected code are retrieved. On the other hand, if the code is not already in the recipient's profile, then decision 340 branches to “no” branch 355 whereupon, at step 360, an exception list is initialized for the selected code.

At step 370, the recipient manages the exception list with regard to the selected status code. During this step, the user can add, delete, or modify sender identifiers that are able to establish instant messaging sessions with the recipient when the recipient's current status set to the selected status code. For example, the recipient can add a new important customer to the exception list allowed to set up an instant messaging session with the recipient when the recipient's status is set to “Do Not Disturb.” A determination is made as to whether more changes are needed to be made to the exception list (decision 375). If more changes are needed, decision 375 branches to “yes” branch 376 which loops back to receive and process the next add/delete/modify request for the exception list. This looping continues until there are no more changes needed to be made to the exception list, at which point decision 375 branches to “no” branch 378.

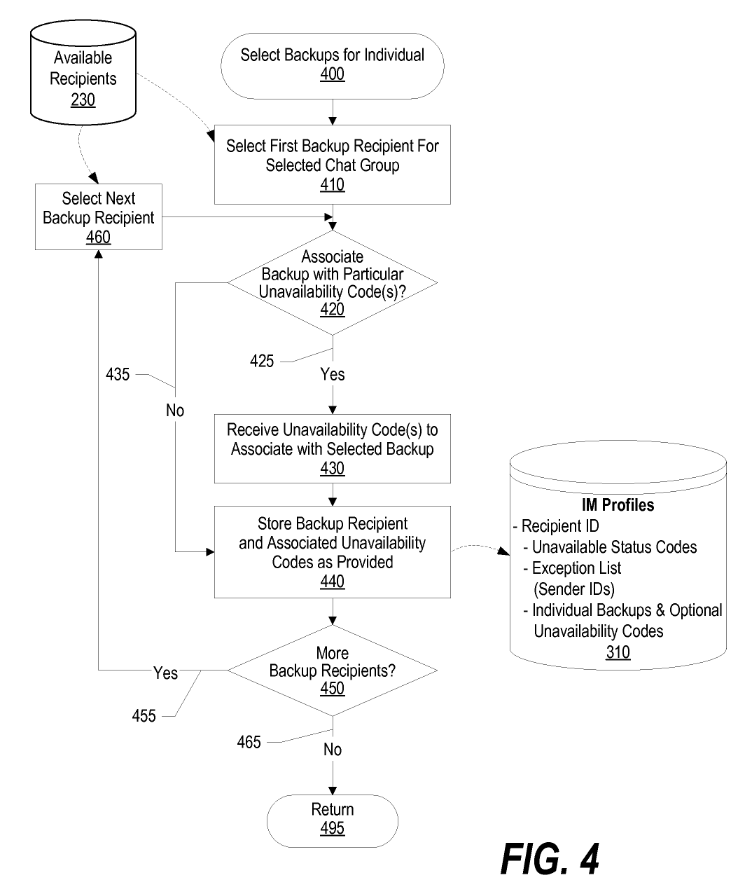

A determination is made as to whether the recipient selects another status code (decision 380). If the user selects another status code, then decision 380 branches to “yes” branch 382 whereupon processing loops back to process the exception list for the newly selected status code. This looping continues until the user does not select another status code to process, at which point decision 380 branches to “no” branch 385. The user then selects the backup recipients that handle instant messaging requests when the recipient is unavailable (predefined process 390, see FIG. 4 and corresponding text for processing details). Processing thereafter ends at 395.

FIG. 4 is a flowchart showing the steps taken to select backup recipients for an individual instant messaging recipient. Processing commences at 400 whereupon, at step 410, the first backup recipient is selected from available recipients 230. A determination is made as to whether to associate the selected backup recipient with any particular status codes (decision 420). For example, the user may want to associate his assistant as a backup if the code is “Do Not Disturb”, but may want a more knowledgeable employee to be associated when the code is “Out of Office.” If the backup recipient is associated with particular status code(s), then decision 420 branches to “yes” branch 425 whereupon, at step 430, the user provides the status codes that are associated with the selected backup recipient. On the other hand, if the selected backup recipient is not being associated with any particular status code(s), then decision 420 branches to “no” branch 435 bypassing step 430.

At step 440, the backup recipient is stored along with any associated status codes (if provided) in the recipient's instant messaging profile 310. A determination is made as to whether there are more backup recipients to select for this recipient (decision 450). If there are more backup recipients to select, then decision 450 branches to “yes” branch 455 whereupon, at step 460, the next backup recipient is selected at step 460 and processing loops back to process and store the newly selected backup recipient. This looping continues until there are no more backup recipients to select for this recipient, at which point decision 450 branches to “no” branch 465 and processing returns to the calling routine at 495.

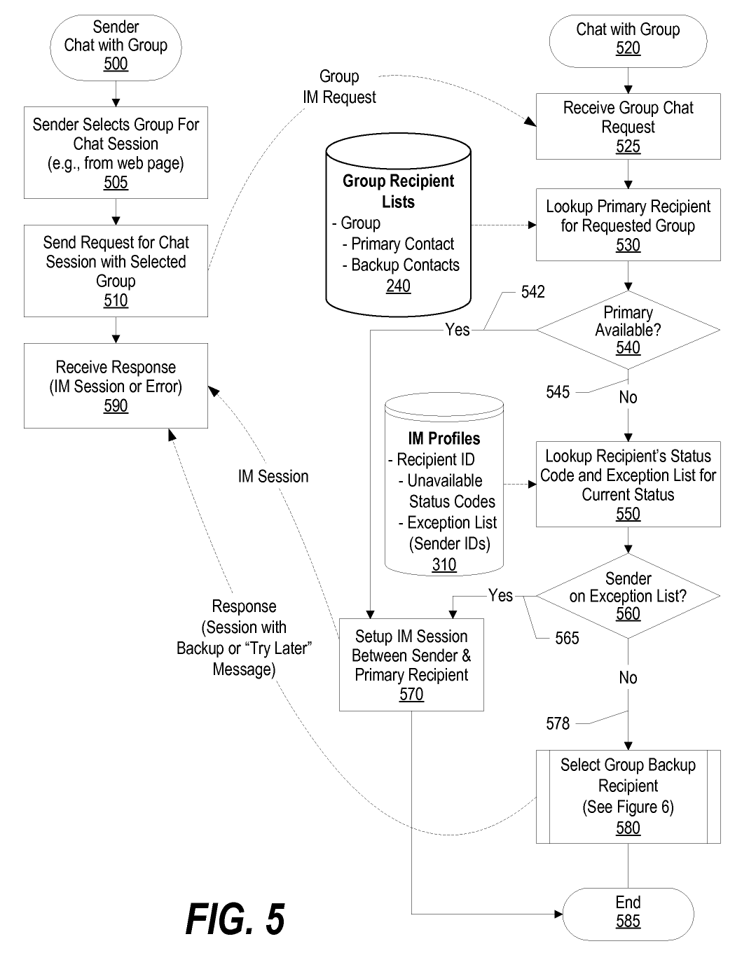

FIG. 5 is a flowchart showing the steps taken during an instant messaging session with a group that includes instant messaging backups. The sender's processing commences at 500 when, at step 505, the sender selects a group with which the sender wishes to establish an instant messaging session. For example, when at a home improvement store's web page, the user may have requested an instant messaging from someone in the plumbing department. At step 510, the request for an instant messaging session with the selected group is sent to a server (e.g., the home improvement store's server that handles instant messaging requests).

Recipient processing commences at 520 with the server that provides the recipients with instant messaging service receives a group instant messaging request at step 525. At step 530, recipient group lists 240 are searched in order to identify the primary recipient for the requested group. A determination is made as to whether the primary recipient is available (decision 540). If the primary recipient is available, decision 540 branches to “yes” branch 542 whereupon, at step 570, an instant messaging session is established between the sender and the primary recipient. On the other hand, if the primary recipient's status code indicates that the primary recipient is unavailable (e.g., “Do Not Disturb”), then decision 540 branches to “no” branch 545.

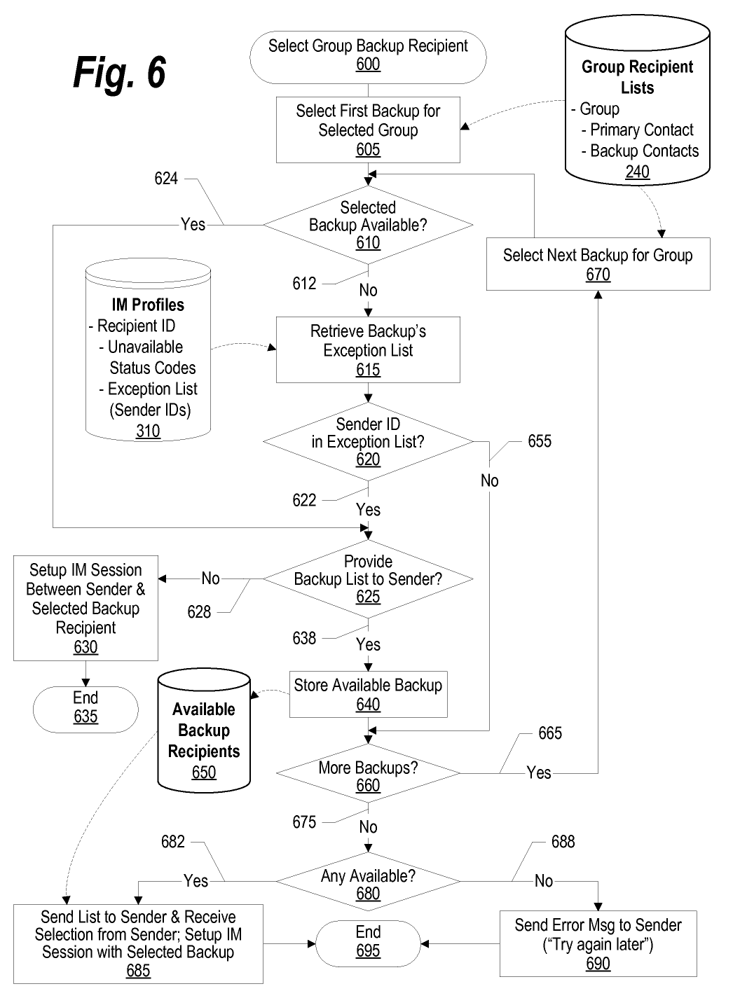

At step 550, the primary recipient's status code is retrieved from the primary recipient's instant messaging profile 310 along with the exception list of sender identifiers that are permitted to establish instant messaging sessions when the recipient's status code is set (e.g., when the recipient's status code is “Do Not Disturb”). A determination is made as to whether the sender's identifier is one of the identifiers on the exception list for the status code (decision 560). If the sender is on the exception list, then decision 560 branches to “yes” branch 565 whereupon, at step 570, an instant messaging session is established between the sender and the primary recipient. On the other hand, if the sender's identifier is not on the exception list, then decision 560 branches to “no” branch 578 whereupon, at predefined process 580, a backup recipient is selected (see FIG. 6 and corresponding text for processing details). Recipient processing of the instant messaging group request thereafter ends at 585.

Returning to sender's processing, at step 590, the sender receives a response. The response is either an instant messaging session with either the primary recipient or one of the backup recipients or an error message if no recipients are available.

FIG. 6 is a flowchart showing the steps taken to select a group backup recipient for an instant messaging session. Processing commences at 600 whereupon, at step 605, the first backup recipient is selected for the selected group from recipient group lists 240 (e.g., the first backup in the plumbing department when the primary recipient is unavailable). A determination is made as to whether the selected backup recipient is available (decision 610). If the selected backup recipient is not available, then decision 610 branches to “no” branch 612 whereupon, at step 615, the list of sender identifiers in the backup recipient's exception list is retrieved from the backup recipient's instant messaging profile 310. For example, a somewhat important customer may not be identified in the primary recipient's exception list but may be listed in the backup recipient's exception list. A determination is made as to whether the sender's identifier is in the backup recipient's exception list (decision 620).

If either (a) the selected backup recipient is available, or (b) the sender identifier is in one of the backup recipients exception lists (decision 620 branching to “yes” branch 622), then a determination is made as to whether to provide a backup list to the sender (decision 625). If a backup list is not being provided to the sender, then decision 625 branches to “no” branch 628 whereupon, at step 630, an instant messaging session is set up between the sender and the first identified available backup recipient and processing returns to the calling routine at 635. On the other hand, if a backup list is being provided, then decision 625 branches to “yes” branch 638 whereupon, at step 640, the identified available backup recipient is stored in available backup recipients list 650. Returning to decision 620, if the backup recipient is unavailable and the sender identifier is not in the exception list, then decision 620 branches to “no” branch 655 bypassing steps 625 through 640.

A determination is made as to whether there are more potential backup recipients for the group (decision 660). If there are more potential backup recipients, then decision 660 branches to “yes” branch 665 whereupon, at step 670, the next potential backup recipient is selected from recipient group list 240 and processing loops back to determine if the newly selected backup recipient is available to the sender for an instant messaging session. On the other hand, if there are no more potential backups, decision 660 branches to “no” branch 675 whereupon another determination is made as to whether any available backup recipients have been identified (decision 680). If available backup recipients have been identified, then decision 680 branches to “yes” branch 682 whereupon, at step 685, (a) the list of available backup recipients is retrieved from data store 650 and sent to the sender, (b) one of the available backup recipients is selected by the sender, and (c) an instant messaging session is established between the sender and the selected backup recipient. On the other hand, if no available backup recipient was identified, then decision 680 branches to “no” branch 688 whereupon, at step 690, an error message is returned to the sender indicting that no instant messaging recipients are currently available and asking the sender to try again at a later time. Processing thereafter ends at 695.

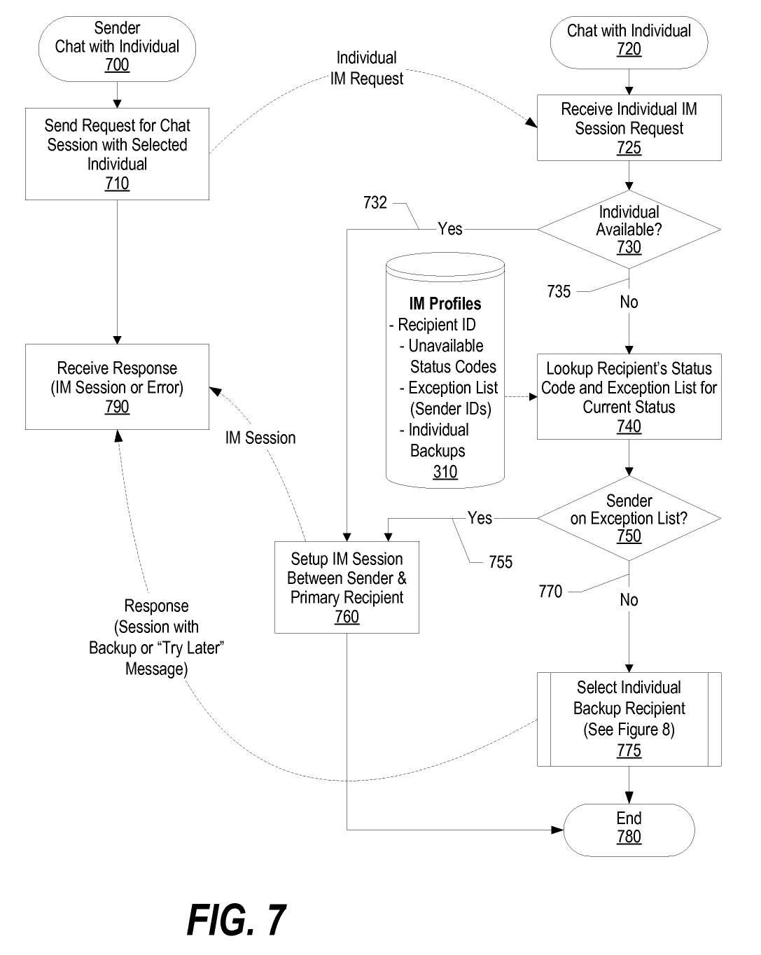

FIG. 7 is a flowchart showing the steps taken during an instant messaging session with individual that has designated instant messaging backup recipients. Sender processing commences at 700 when, at step 710, the sender sends a request for an instant messaging session with a particular individual (the primary recipient).

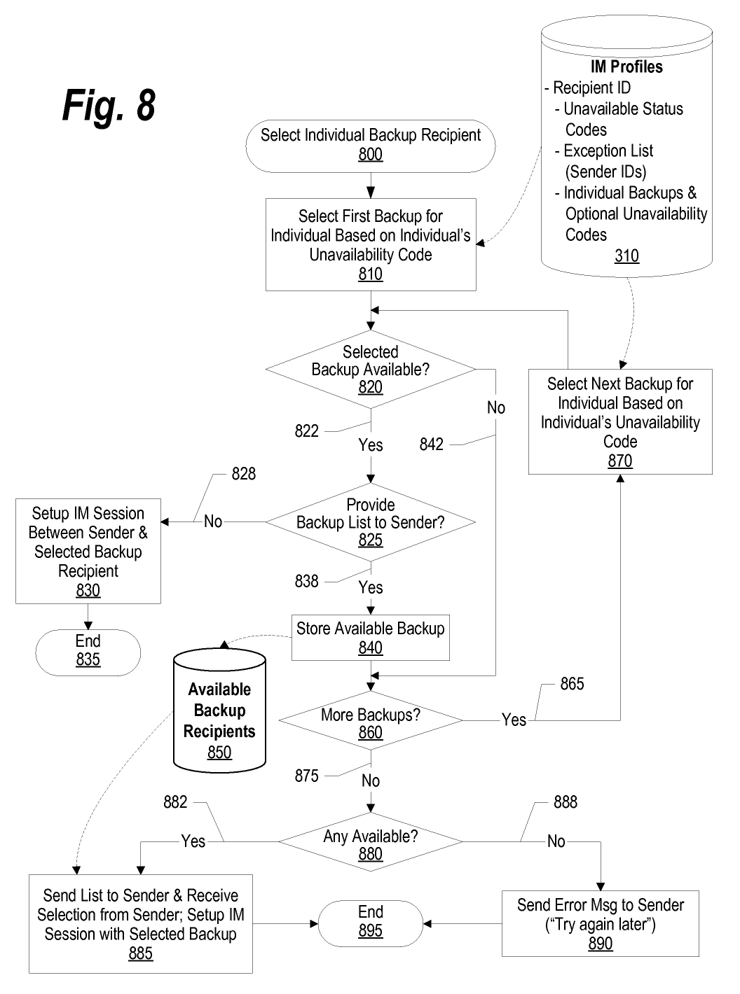

Recipient processing commences at 720 when, at step 725, the server handling instant messaging requests for the primary recipient receives the request from the sender. A determination is made as to whether the primary recipient is available (decision 730). If the primary recipient is available, then decision 730 branches to “yes” branch 732 whereupon, at step 760, an instant messaging is established between the sender and the primary recipient. On the other hand, if the primary recipient has a status code indicating that the primary recipient is generally unavailable (e.g., a status code of “Do Not Disturb”), then decision 730 branches to ““no” branch 735 whereupon, at step 740, the primary recipient's instant messaging profile 310 is searched for sender identifiers in an exception list that includes the primary recipient's current status. A determination is made as to whether the sender is on the exception list. If the sender's identifier is included in the primary recipient's exception list, then decision 750 branches to “yes” branch 755 whereupon, at step 760, an instant messaging is established between the sender and the primary recipient. On the other hand, if the sender is not on the primary recipient's exception list, then decision 750 branches to “no” branch 770 whereupon, at predefined process 775 an individual backup recipient is selected (see FIG. 8 and corresponding text for processing details). Processing thereafter ends at 780.

Returning to sender's processing, at step 790, the sender receives a response. The response is either an instant messaging session with either the primary recipient or one of the backup recipients, or an error message if neither the primary recipient nor any of the primary recipient's backups are currently available.

FIG. 8 is a flowchart showing the steps taken to select an individual backup recipient for an instant messaging session. Processing commences at 800 whereupon, at step 810, the first backup recipient is selected for the individual primary recipient based upon data in the primary recipient's instant messaging profile 310. The primary recipient may have designated backup recipients based upon particular status codes or may have designated backup recipients generally without regard to any particular status codes. For example, the primary recipient may have chosen one list of backup recipients when the primary recipient's status code is “Do Not Disturb” and another list of backup recipients when the primary recipient's recipient status code is “Out of Office.” If backup recipients were designated generally, then the list of backup recipients for the primary recipient is used without regard to what the primary recipient's particular reason for being unavailable (e.g., the same list of backup recipients is used when the primary recipient's status code is “Do Not Disturb” or “Out of Office).

A determination is made as to whether the selected backup recipient is available (decision 820). If the selected backup recipient is available, then decision 820 branches to “yes” branch 822 whereupon a determination is made as to whether a list of available backup recipients is being provided to the sender (decision 825). This determination may be a general determination set by the recipient's server or may be made either based upon the particular sender (e.g., the importance level of a sender), or based on a preference set by the sender indicating whether the sender wishes to have an instant messaging session with the first available backup recipient or wishes to select an available backup recipient from a list. If a backup list is not being provided to the sender, then decision 825 branches to “no” branch 828 when the first available backup recipient is identified, at which point an instant messaging session is set up between the sender and the first identified backup recipient at step 830 and processing ends at 835. On the other hand, if a backup list is being provided to the sender, then decision 825 branches to “yes” branch 838 whereupon, at step 840, the identified available backup recipient is stored in list of available backup recipients 850.

A determination is made as to whether there are more potential backup recipients to process (decision 860). If there are more potential backup recipients to process, then decision 860 branches to “yes” branch 865 whereupon, at step 870, the next potential backup recipient is selected from the primary recipient's instant messaging profile 310 and processing loops back to process the newly selected potential backup recipient. This looping continues until either a session is established with one of the backup recipients using step 830 or the list of potential backup recipients is exhausted, at which point decision 860 branches to “no” branch 875.

A determination is made as to whether any available backup recipients were identified (decision 880). If available backup recipients were identified, then decision 880 branches to “yes” branch 882 whereupon, at step 885, (a) the list of available backup recipients is retrieved from data store 850 and sent to the sender, (b) one of the available backup recipients is selected by the sender, and (c) an instant messaging session is established between the sender and the selected backup recipient. On the other hand, if no backup recipients are currently available, then decision 880 branches to “no” branch 888 whereupon, at step 890, an error message is returned to the sender indicting that no instant messaging recipients are currently available and asking the sender to try again at a later time. Processing thereafter ends at 895.

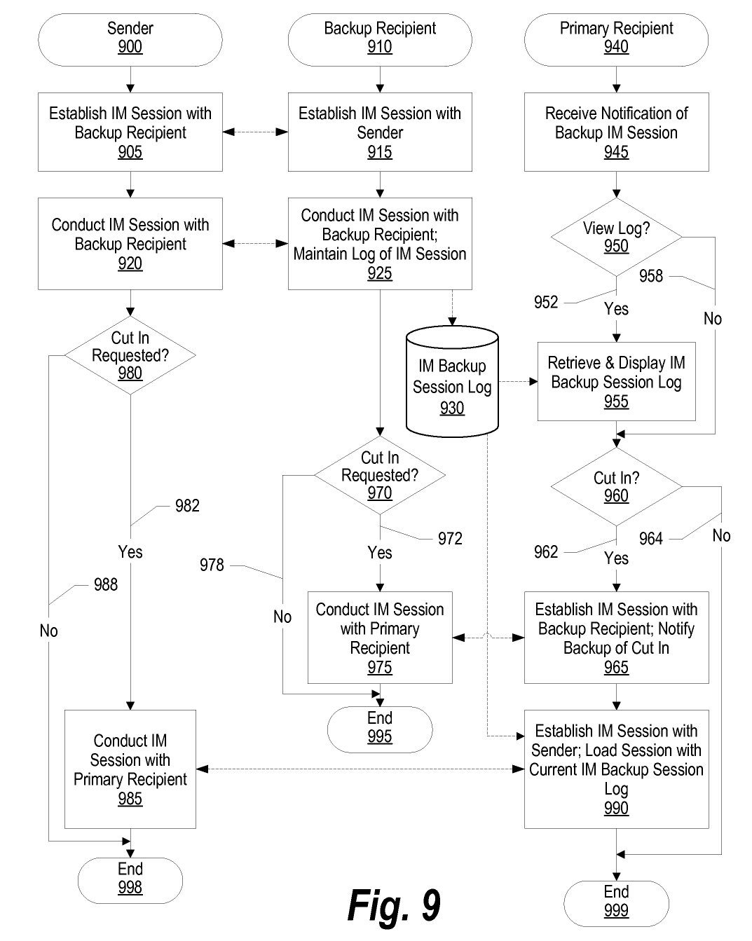

FIG. 9 is a flowchart showing the steps taken to allow a primary recipient to cut into a session between a sender and a backup recipient. Sender processing commences at 900 when, at step 905, an instant messaging session is established between the sender and a backup recipient. Likewise, backup recipient processing commences at 910 when, at step 915, the instant messaging session is established. At steps 920 and 925, the instant messaging session is conducted between the sender and the backup recipient and the messages send and received during the session are stored in instant messaging backup session log 930.

Primary recipient processing commences at 940 when, at step 945, the primary recipient is notified that an instant messaging session is being conducted between the sender and a backup recipient. A determination is made as to whether the primary recipient wishes to view the session log (decision 950). If the primary recipient requests to view the session log, then decision 950 branches to “yes” branch 952 whereupon, at step 955, the instant messaging session log is retrieved and displayed on the primary recipient's display device. On the other hand, if the primary recipient does not wish to view the session log, then decision 950 branches to “no” branch 958 bypassing step 955.

A determination is made as to whether the primary recipient is requesting to “cut in” or establish a new instant messaging session between the primary recipient and the sender (decision 960). If the primary recipient requests to establish a connection, then decision 960 branches to “yes” branch 962 whereupon, at step 965, an instant messaging session is established between the primary recipient and the backup recipient and, at step 990, an instant messaging session is established between the primary recipient and the sender and the session is pre-loaded with the session log so that the primary recipient can review the instant messages that have been sent between the backup recipient and the sender. On the other hand, if the primary recipient does not request to “cut in”, then decision 960 branches to “no” branch 964 bypassing steps 965 and 990 and primary recipient processing ends at 999.

Returning to backup recipient processing, a determination is made as to whether the primary recipient requested to “cut in” (decision 970). If the primary recipient requested to cut in, then decision 970 branches to “yes” branch 972 whereupon, at step 975 an instant messaging session is conducted between the backup recipient and the primary recipient. On the other hand, if a “cut in” was not requested, then decision 970 branches to “no” branch 978 bypassing step 975 and backup recipient processing eventually ends at 995.

Returning to sender processing, a determination is made as to whether the primary recipient requested to “cut in” (decision 980). If the primary recipient requested to cut in, then decision 980 branches to “yes” branch 982 whereupon, at step 985 an instant messaging session is conducted between the sender and the primary recipient. On the other hand, if a “cut in” was not requested, then decision 980 branches to “no” branch 988 bypassing step 985 and backup recipient processing eventually ends at 998.

In one embodiment, when a “cut in” is requested, separate instant messaging sessions are conducted between the sender and the backup recipient, the primary recipient and the backup recipient, and between the primary recipient and the sender. In another embodiment, when a “cut in” is requested, the primary recipient joins as a participant to the instant messaging session that was established in steps 905 and 915. The embodiment used by an organization may be based on the types of issues and questions addressed in instant messaging sessions and the sensitivity of such discussions as well as whether “off line” discussions between the backup recipient and the primary recipient are advantageous.

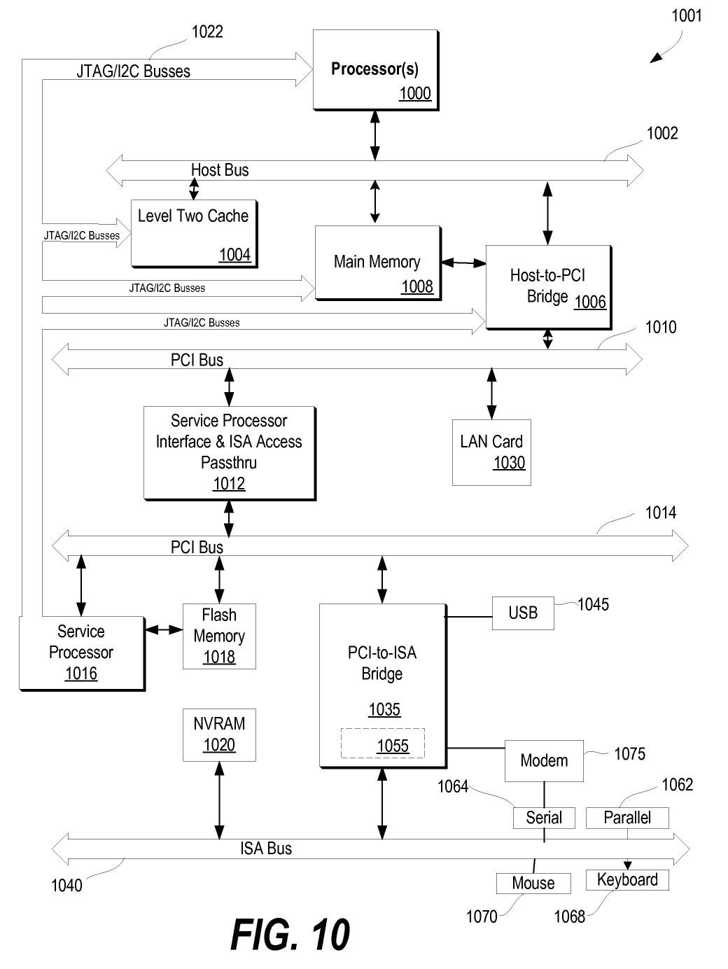

FIG. 10 illustrates information handling system 1001 which is a simplified example of a computer system capable of performing the computing operations described herein. Computer system 1001 includes processor 1000 which is coupled to host bus 1002. A level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and I2C busses 1022 for communication with processor(s) 1000 during initialization steps. JTAG/I2C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While FIG. 10 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a software application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method of providing instant messaging backups, said method comprising:
receiving, over a computer network, an instant messaging request from a sender, the instant messaging request requesting an instant messaging session with a primary recipient;
determining whether the primary recipient is available;
setting up the instant messaging session with the primary recipient in response to the determination being that the primary recipient is available; and
in response to the determination being that the primary recipient is unavailable:
retrieving one or more stored backup recipient identifiers corresponding to one or more backup recipients associated with the primary recipient;
identifying at least one available backup recipient identifier from the one or more stored backup recipient identifiers, the identified available backup recipient identifiers corresponding to at least one of the backup recipients that are available; and
setting up the instant messaging session with one of the available backup recipients using one of the identified available backup recipient identifiers.

2. The method of claim 1 wherein the determining further comprises:
retrieving an availability code corresponding to the primary recipient;
in response to identifying that the retrieved availability code signifies that the primary recipient is unavailable:
retrieving one or more preferred sender identifiers corresponding to the primary recipient; and
comparing a sender identifier corresponding to the sender with the preferred sender identifiers, wherein the determination is that the primary recipient is available if the sender identifier matches one of the preferred sender identifiers, and wherein the determination is that the primary recipient is unavailable if the sender identifier fails to match one of the preferred sender identifiers.

3. The method of claim 1 further comprising:
receiving the instant messaging request, wherein the instant messaging request requesting the instant messaging session with an instant messaging group; and
retrieving a primary recipient identifier corresponding to the primary recipient and the stored backup recipient identifiers from a data source based on the requested instant messaging group.

4. The method of claim 1 wherein the at least one available backup recipient identifier includes a plurality of available backup recipient identifiers, the method further comprising:
returning the plurality of available backup recipient identifiers to the sender via the computer network; and
receiving, from the sender, a selected backup recipient identifier selected by the sender from the plurality of available backup recipient identifiers, wherein the one of the identified available backup recipient identifiers is the selected backup recipient identifier.

5. The method of claim 1 further comprising:
conducting the instant messaging session between the sender and the one of the identified available backup recipient identifiers; and
storing an instant messaging session log corresponding to the instant messaging session during the conducting, wherein the stored instant messaging session log is accessible to the primary recipient.

6. The method of claim 5 further comprising:
subsequent to setting up the instant messaging session with one of the available backup recipients:
receiving a request from the primary recipient; and
displaying the stored instant messaging session log on a display device accessible to the primary recipient in response to the request from the primary recipient.

7. The method of claim 5 further comprising:
subsequent to setting up the instant messaging session with one of the available backup recipients:
receiving a request from the primary recipient;
establishing a second instant messaging session between the primary recipient and the sender in response to the request from the primary recipient, wherein the establishing includes copying the stored instant messaging session log to the second instant messaging session.

8. A information handling system comprising:
one or more processors;
a memory accessible by at least one of the processors;
a nonvolatile storage area accessible by at least one of the processors;
a network interface adapter connecting the information handling system to a computer network; and
a set of instructions stored in the memory, wherein one or more of the processors executes the set of instructions in order to perform actions of:
receiving, over a computer network, an instant messaging request from a sender, the instant messaging request requesting an instant messaging session with a primary recipient;
determining whether the primary recipient is available;
setting up the instant messaging session with the primary recipient in response to the determination being that the primary recipient is available; and
in response to the determination being that the primary recipient is unavailable:
retrieving one or more stored backup recipient identifiers corresponding to one or more backup recipients associated with the primary recipient;
identifying at least one available backup recipient identifier from the one or more stored backup recipient identifiers, the identified available backup recipient identifiers corresponding to at least one of the backup recipients that are available; and
setting up the instant messaging session with one of the available backup recipients using one of the identified available backup recipient identifiers.

9. The information handling system of claim 8 wherein the set of instructions that perform the action of determining perform further actions comprising:
retrieving an availability code corresponding to the primary recipient;
in response to identifying that the retrieved availability code signifies that the primary recipient is unavailable:
retrieving one or more preferred sender identifiers corresponding to the primary recipient; and
comparing a sender identifier corresponding to the sender with the preferred sender identifiers, wherein the determination is that the primary recipient is available if the sender identifier matches one of the preferred sender identifiers, and wherein the determination is that the primary recipient is unavailable if the sender identifier fails to match one of the preferred sender identifiers.

10. The information handling system of claim 8 wherein the set of instructions perform further actions comprising:
receiving the instant messaging request, wherein the instant messaging request requesting the instant messaging session with an instant messaging group; and
retrieving a primary recipient identifier corresponding to the primary recipient and the stored backup recipient identifiers from a data source based on the requested instant messaging group.

11. The information handling system of claim 8 wherein the at least one available backup recipient identifier includes a plurality of available backup recipient identifiers, and wherein the set of instructions perform further actions comprising:
returning the plurality of available backup recipient identifiers to the sender via the computer network; and
receiving, from the sender, a selected backup recipient identifier selected by the sender from the plurality of available backup recipient identifiers, wherein the one of the identified available backup recipient identifiers is the selected backup recipient identifier.

12. The information handling system of claim 8 further comprising wherein the set of instructions perform further actions comprising:
conducting the instant messaging session between the sender and the one of the identified available backup recipient identifiers; and
storing an instant messaging session log corresponding to the instant messaging session during the conducting, wherein the stored instant messaging session log is accessible to the primary recipient.

13. The information handling system of claim 12 wherein the set of instructions perform further actions comprising:
subsequent to setting up the instant messaging session with one of the available backup recipients:
receiving a request from the primary recipient;
establishing a second instant messaging session between the primary recipient and the sender in response to the request from the primary recipient, wherein the establishing includes copying the stored instant messaging session log to the second instant messaging session.

14. A computer program product stored in a computer readable medium, comprising functional descriptive material that, when executed by an information handling system, causes the information handling system to perform actions that include:
receiving, over a computer network, an instant messaging request from a sender, the instant messaging request requesting an instant messaging session with a primary recipient;
determining whether the primary recipient is available;
setting up the instant messaging session with the primary recipient in response to the determination being that the primary recipient is available; and
in response to the determination being that the primary recipient is unavailable:
retrieving one or more stored backup recipient identifiers corresponding to one or more backup recipients associated with the primary recipient;
identifying at least one available backup recipient identifier from the one or more stored backup recipient identifiers, the identified available backup recipient identifiers corresponding to at least one of the backup recipients that are available; and
setting up the instant messaging session with one of the available backup recipients using one of the identified available backup recipient identifiers.

15. The computer program product of claim 14 wherein the determining further includes additional functional descriptive material that causes the information handling system to perform additional actions comprising:
retrieving an availability code corresponding to the primary recipient;
in response to identifying that the retrieved availability code signifies that the primary recipient is unavailable:
retrieving one or more preferred sender identifiers corresponding to the primary recipient; and
comparing a sender identifier corresponding to the sender with the preferred sender identifiers, wherein the determination is that the primary recipient is available if the sender identifier matches one of the preferred sender identifiers, and wherein the determination is that the primary recipient is unavailable if the sender identifier fails to match one of the preferred sender identifiers.

16. The computer program product of claim 14 wherein the functional descriptive material causes the information handling system to perform further actions comprising:
receiving the instant messaging request, wherein the instant messaging request requesting the instant messaging session with an instant messaging group; and
retrieving a primary recipient identifier corresponding to the primary recipient and the stored backup recipient identifiers from a data source based on the requested instant messaging group.

17. The computer program product of claim 14 wherein the at least one available backup recipient identifier includes a plurality of available backup recipient identifiers, and wherein the functional descriptive material causes the information handling system to perform further actions comprising:
returning the plurality of available backup recipient identifiers to the sender via the computer network; and
receiving, from the sender, a selected backup recipient identifier selected by the sender from the plurality of available backup recipient identifiers, wherein the one of the identified available backup recipient identifiers is the selected backup recipient identifier.

18. The computer program product of claim 14 wherein the functional descriptive material causes the information handling system to perform further actions comprising:
conducting the instant messaging session between the sender and the one of the identified available backup recipient identifiers; and
storing an instant messaging session log corresponding to the instant messaging session during the conducting, wherein the stored instant messaging session log is accessible to the primary recipient.

19. The computer program product of claim 18 wherein the functional descriptive material causes the information handling system to perform further actions comprising:
subsequent to setting up the instant messaging session with one of the available backup recipients:
receiving a request from the primary recipient; and
displaying the stored instant messaging session log on a display device accessible to the primary recipient in response to the request from the primary recipient.

20. The computer program product of claim 18 wherein the functional descriptive material causes the information handling system to perform further actions comprising:
subsequent to setting up the instant messaging session with one of the available backup recipients:
receiving a request from the primary recipient;
establishing a second instant messaging session between the primary recipient and the sender in response to the request from the primary recipient, wherein the establishing includes copying the stored instant messaging session log to the second instant messaging session.
